(19) United States
(12) Patent Application Publication
(10) Pub. No.: US 2007/0195293 A1
(43) Pub. Date: Aug. 23, 2007

(54) Projection type image display apparatus

(75) Inventors: Nobuyuki Kaku, Oiso (JP); Yoshinori Horikawa, Hiratsuka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/512,990

(22) Filed: Aug. 29, 2006

(30) Foreign Application Priority Data
Feb. 22, 2006 (JP) 2006-045111

(51) Int. Cl. G03B 21/22; G03B 21/14

(52) U.S. Cl. 353/119

(57) ABSTRACT

The projection type image display apparatus according to the present invention has an engagement portion enabling engagement and disengagement between a first base and a second base. The first base supports a portion for forming an optical image and a projection lens in an optical system unit. The second base supports a power circuit or a controlling circuit for controlling the portion for forming an optical image in a circuit system unit. The optical system unit and the circuit system unit can be accommodated in the coupled state in a housing of the apparatus.

### Claim of Priority

The present application claims priority from Japanese application serial No. P2006-045111, filed on Feb. 22, 2006, the content of which is hereby incorporated by reference into this application.

### BACKGROUND OF THE INVENTION

1. Field of the Invention

The present invention relates to a projection type image display apparatus for forming an optical image and projects the optical image onto a screen in the enlarged state in response to an image signal. More specifically, this invention relates to a configuration of a base for supporting an optical system unit or a circuit system unit.

2. Description of the Related Art

For instance, JP Publication No. Hei 05-153533 describes a configuration of a rear projection type image display apparatus. In the rear projection type image display apparatus, both a projection tube projecting portion 7 and an electric circuit accommodating portion 6 are provided on a base frame 9 in a lower cabinet 8. The base frame 9 can easily be removed from the lower cabinet 8 to improve the workability during the manufacturing, maintenance, and other operations.

### SUMMARY OF THE INVENTION

In the invention disclosed in JP Publication No. Hei 05-153533, both of the projection tube projecting portion 7 and the electric circuit accommodating portion 6 can be removed with the base frame 9 from the lower cabinet 8. That is, both of the projection tube projecting portion 7 and the electric circuit accommodating portion 6 assembled on the base frame 9 can be removed from the lower cabinet 8. Because of the configuration as described above, when the electric circuit accommodating portion 6 is taken out from the lower cabinet 8 for adjustment of the performance, repair, check, or for any other purpose, it is necessary to take out the projection tube projecting portion 7 together with the base frame 9 from the lower cabinet 8. Thus, it will be time-consuming since the large-scale work is required. In addition, there is a possibility that the projection tube projecting portion 7 may be damaged during the work for taking out from the lower cabinet 8. Further, since the projection tube projecting portion 7 is correctly positioned at a predetermined position in the lower cabinet 8, a position at which an image is projected onto a screen is correctly determined. If the projection tube projecting portion 7 is taken out, the position at which an image is projected may be changed from the correct position on the screen. In some cases, readjustment of the position for projection and the like may be required.

The present invention was made in the light of the circumstances as described above. It is an issue of the present invention is to facilitate such works as adjustment, repair, check and other operations after a circuit system is assembled in a projection type image display apparatus, and reduce the time for such works for assembling the apparatus with improving reliability.

It is an object of the present invention is to provide a projection type image display apparatus for which such works as performance adjustment, repair, and check can easily be performed for achieving the issue described above.

To solve the problems described above, the projection type image display apparatus according to the present invention has an engagement portion for engaging a first base with a second base. The first and second bases can be separated from each other. The first base supports a portion for forming an optical image and a projection lens in an optical system unit. The second base supports a power circuit and a controlling circuit for controlling the portion for forming the optical image in a circuit unit. The optical system unit and the circuit system unit are accommodated in a housing in the state where the two units are coupled to each other with the engagement portion.

### BRIEF DESCRIPTION OF THE DRAWINGS

FIG. 1 is a view illustrating a configuration of a projection type image display apparatus according to the present invention.

FIG. 2 is a view showing an appearance of an image beam forming portion in the projection type image display apparatus shown in FIG. 1.

FIGS. 3A to 3C are views each illustrating a configuration of a base for the image beam forming portion shown in FIG. 2.

FIG. 4 is a top view illustrating a surface of a key portion of an engagement portion of the base shown in FIG. 3.

FIG. 5 is a view for illustrating an operation of the engagement portion for engaging the bases shown in FIG. 3.

FIG. 6 is a view illustrating another configuration of an engagement portion for a base in the image beam forming portion shown in FIG. 2.

FIG. 7 is a view for illustrating an operation of the engagement portion for engaging the bases shown in FIG. 6.

FIG. 8 is a view showing an appearance of an optical engine in the projection type image display apparatus shown in FIG. 1.

FIG. 9 is a view for illustrating a configuration for coupling an illumination light optical path portion with a lamp unit in the optical engine shown in FIG. 8.

### DETAILED DESCRIPTION OF THE PREFERRED EMBODIMENTS

Embodiments of the present invention are described below with reference to the related drawings.

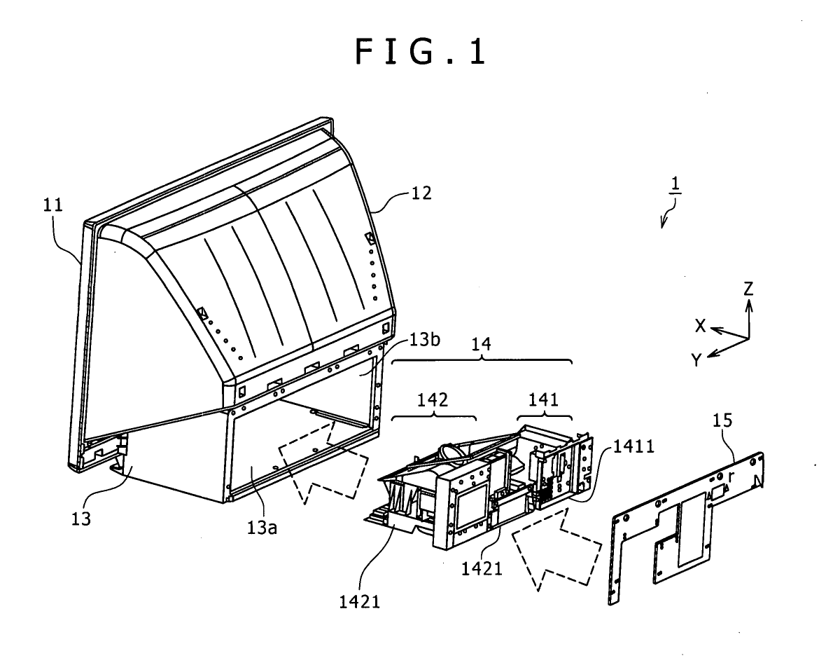

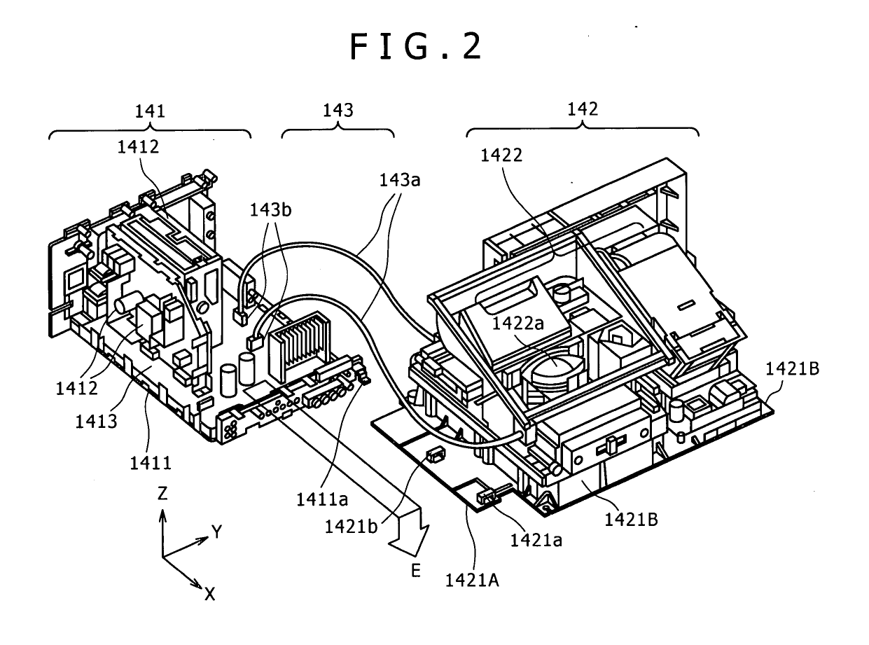

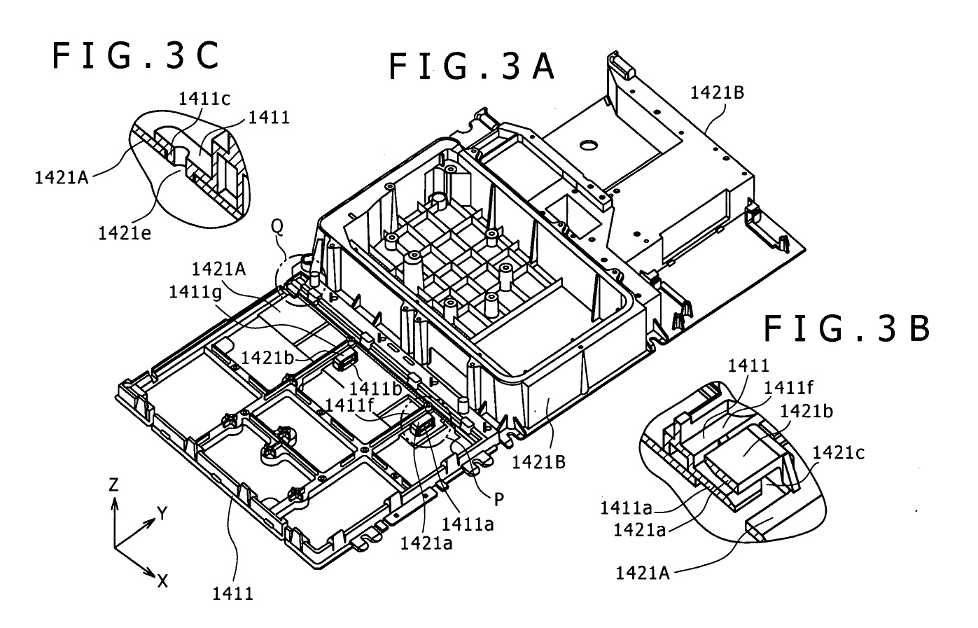

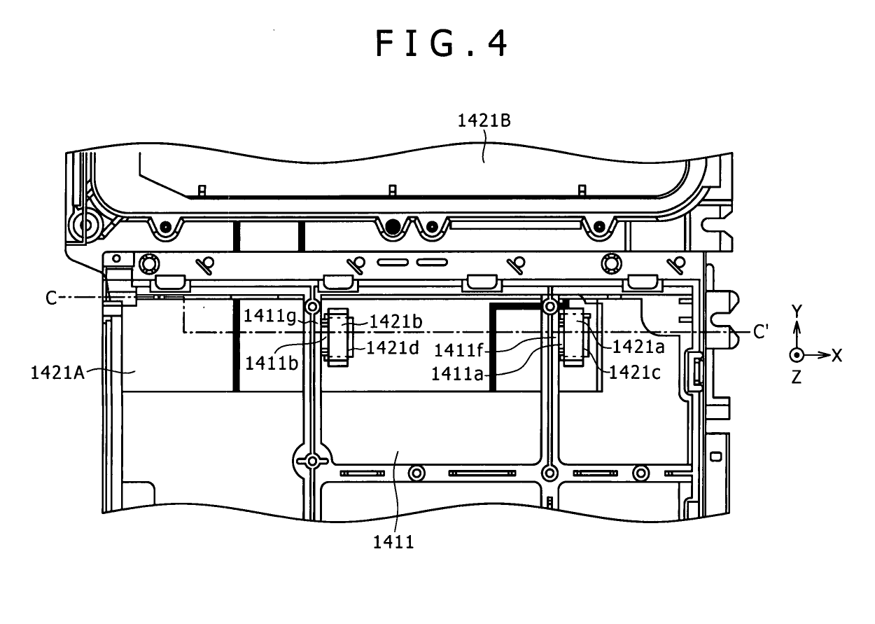

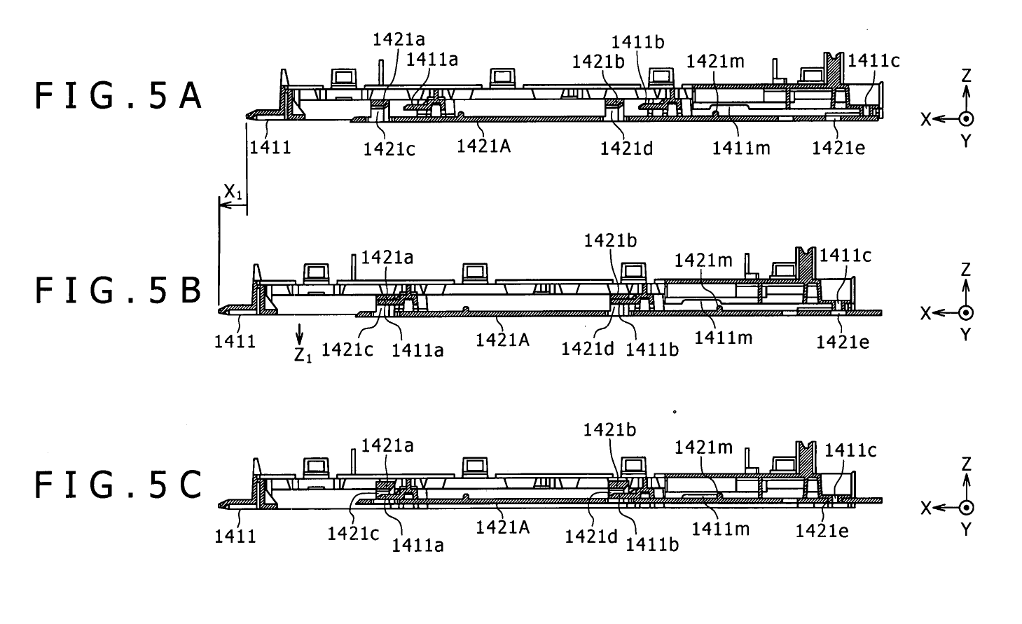

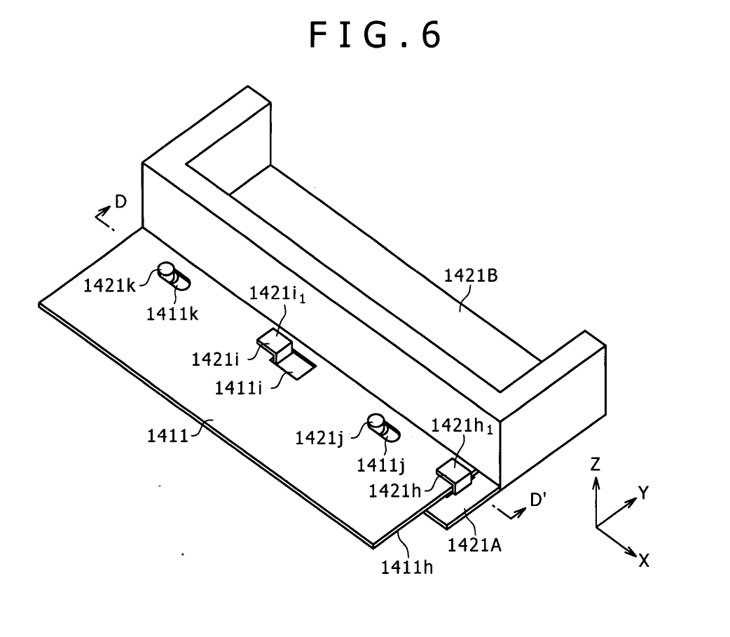

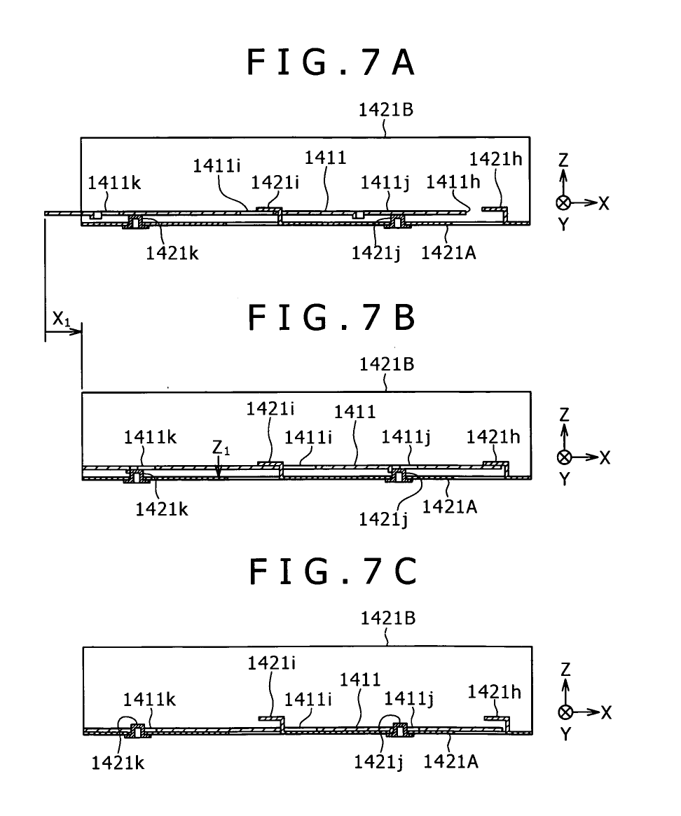

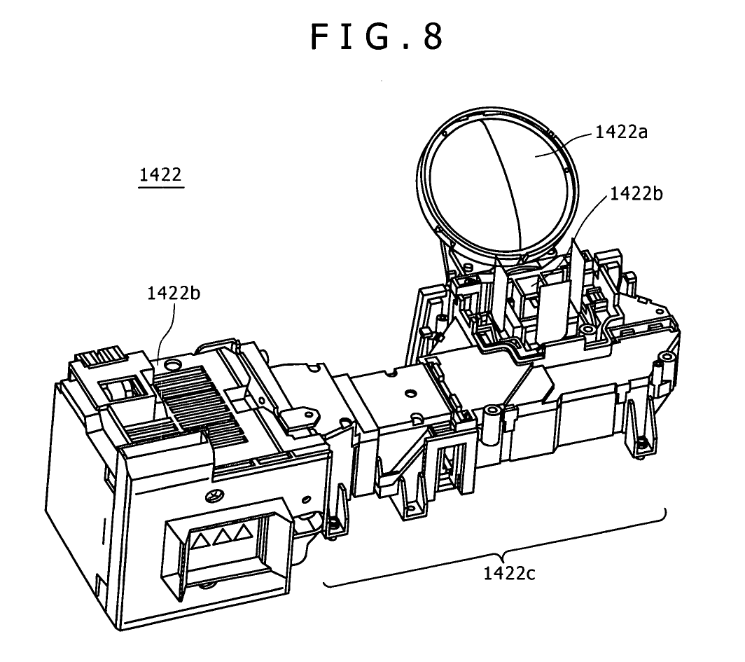

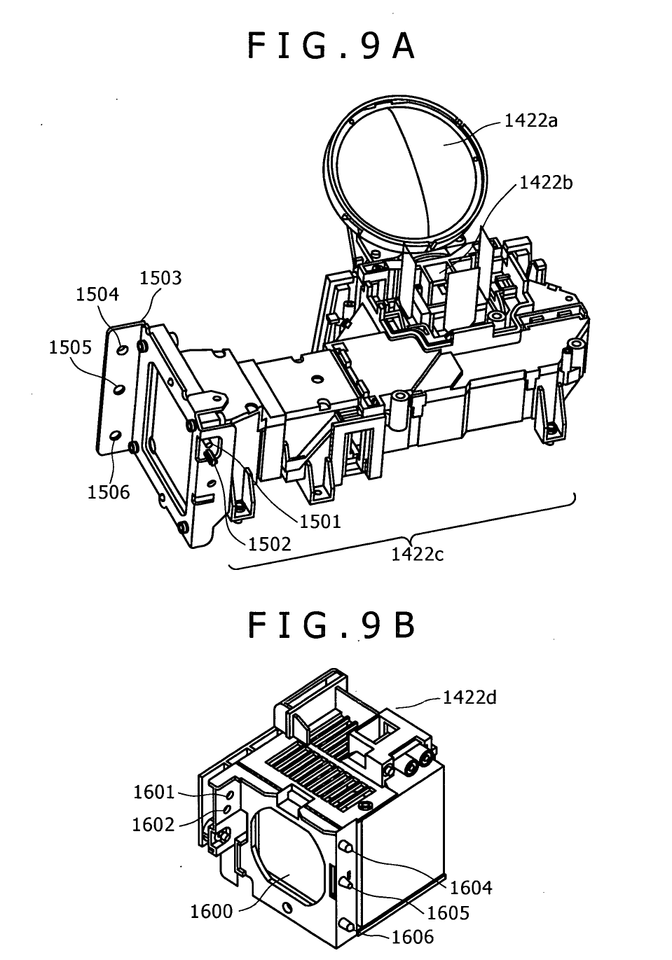

FIG. 1 to FIG. 9 are views for illustrating a projection type image display apparatus according to embodiments of the present invention. The projection type image display apparatus according to the embodiment of the present invention has a configuration in which a light beam from a light source is modulated with a light valve according to an image signal to form an optical image. FIG. 1 is a view illustrating a configuration of a projection type image display apparatus according an embodiment of the present invention; FIG. 2 is a view showing an appearance of an image beam forming portion in the projection type image display apparatus shown in FIG. 1; FIGS. 3A to 3C are views each illustrating a configuration of a base for the image beam forming portion shown in FIG. 2; FIG. 4 is a top view illustrating a key portion of an engagement portion of the base shown in FIG. 3; FIG. 5 is a view for illustrating an operation of the engagement portion for engaging the bases shown in FIG. 3; FIG. 6 is a view illustrating another configuration of an engagement portion for a base in the image beam forming portion shown in FIG. 2; FIG. 7 is a view for illustrating an operation of the engagement portion for engaging the bases shown in FIG. 6; FIG. 8 is a view showing an appearance of an optical engine in the projection type image display apparatus shown in FIG. 1; and FIG. 9 is a view for illustrating a configuration for coupling an illumination light optical path portion with a lamp unit in the optical engine shown in FIG. 8.

In FIG. 1, reference numeral 1 denotes a projection type image display apparatus according to an embodiment of the present invention for forming an optical image by modulating a light beam from a light source with a light valve according to an image signal and projecting the optical image onto a screen in the enlarged state; 11, a screen; 12, an upper cabinet as an upper housing for supporting a portion including the screen 11; 13, a lower cabinet as a lower housing; 13a, an internal space in the lower cabinet 13; 13b, an opening portion provided on a rear surface of the lower cabinet 13, namely on the side opposite to the screen surface (on the minus side in the X-axial direction); 14, an image beam forming portion for forming an image beam to project an image to the screen 11; 141, a circuit system unit constituting a circuit system in the image beam forming portion 14; 142, an optical system unit constituting an optical system in the image beam forming portion 14; 1411, a circuit chassis as a base (a second base) in the circuit system unit 141; 1421, an engine base as a base (a first base) in the optical system unit 142; and 15, a cover on the rear side. The image beam forming portion 14 is accommodated in an internal space 13a of the lower cabinet 13. The rear side cover 15 is fixed to the lower cabinet 13 on the rear face side of the apparatus to cover the opening portion 13b of the lower cabinet 13. The opening portion 13b has the dimensions enabling mounting and dismounting the image beam forming portion 14, namely the optical system unit 142 and the circuit system unit 141. An engine base 1421 as a first base and a circuit chassis 1411 as a second base have engagement portions (not shown) enabling engagement of the two portions in the disengageable state. When engagement portions are engaged with each other, the optical system unit 142 and the circuit system unit 141 are engaged with each other in the disengageable state. Then the two units 142, 141 are engaged with each other, the image beam forming portion 14 is assembled in the internal space 13a of the lower cabinet 13 from the opening portion 13b. The same reference numerals are assigned to portions having the same functions as those shown in FIG. 1. The coordinate axes used in the drawing are common to all of the features.

FIG. 2 is a view showing an appearance of the image beam forming portion 14 in the projection type image display apparatus 1 shown in FIG. 1. In FIG. 2, the reference circuit 1412 denotes circuit parts in the image beam forming portion 14; 1413, a substrate with the circuit parts 1412 wired thereon and fixed to the circuit chassis 1411; 1411a, an engagement portion provided on the circuit chassis 1411; 143, a connecting portion for electrically connecting the circuit system unit 141 and the optical system unit 142 to each other; 143a, a connecting line; 143b, a connector; 1422, an optical engine constituting the optical system unit 142; 1422a, a projection lens for projecting an image light beam in the enlarged state; 1421a and 1421b, engagement portions provided on the engine base 1421; 1421a, a portion of the engine base 1421 on which the engagement portions 1421a, 1421b are provided (this portion is also referred to as an engine base); and 1421b, a portion of the engine base 1421 on which the optical engine 1422 or the projection lens 1422a is provided (this portion is also referred to as an engine base).

The engagement portions 1421a, 1421b define open spaces extending on a plane of the engine base 1421A respectively, and the engagement portions of the circuit chassis 1411 (1411a and the like) are inserted for engagement. The engagement portion 1421a on the engine base 1421 is engaged with the engagement portion 1411a on the circuit chassis 1411, while the engagement portion 1421b is engaged with another engagement portion (not shown) on the circuit chassis 1411. Engagement between the engagement portions on the engine base 1421 and those on the circuit chassis 1411 is carried out by moving the circuit system unit 141 toward the optical system unit 142 in the direction of an arrow E, that is, by moving the circuit chassis 1411 toward the engine base 1421 (1421A, 1421B) in the direction of the arrow E. The direction of the arrow E is equivalent to the X-axial direction as well as to the -Z-axial direction.

The circuit parts 1412 constitutes a power circuit for supplying power to a light source (not shown) or a light valve in the optical system unit 142, a controlling circuit for controlling the light valve according to an image signal and the like in the circuit system unit 141. The power circuit and the controlling circuit above are formed with circuit parts 1412 wired on the substrate 1413, and the substrate 1413 is fixed in a region different from the region of the circuit chassis 1411 on which the engagement portions 141a, 1411b are provided.

The optical engine 1422 comprises a light source, a light valve, an optical member for processing and guiding a light beam from the light source to the light valve, a projection lens 1422a and the like each provided in the optical unit 142. The optical engine 1422 subjects a light beam from the light source to such processing as polarization and optical conversion or color separation, and irradiates the colored light beams having been subjected to the processing as described above to the light valve. The optical engine 1422 furthermore modulates the irradiated colored light beams with the light valve according to an image signal, outputs optical image light beams for the colored light beams from the light valve, synthesizes the colored light beams to an optical image light which is a white light beam, enlarges the optical image light beam with the projection lens 1422a, and projects the optical image light beam to a mirror (not shown). The connector 143b constituting the connecting portion 143 is connected with wire to the substrate 1413. Power for driving is supplied from a power circuit (now shown) in the circuit system unit via the substrate 1413, connector 143b, and connection line 143a to a light source (not shown) or a light valve (not shown) in the optical system unit 142, and also delivery of an image signal to the light valve is performed from the controlling circuit in the circuit system unit via the substrate 1413, connector 143b, and connection line 143a. Since the optical system unit 142 and the circuit system unit 141 can be connected to each other at the connecting portion 143, the work is easier as compared to a case where the optical system unit 142 and the optical system unit 142 are set in the lower cabinet 13 and then the two units are connected to each other. As a result, also the reliability in connection is improved.

The same reference numerals used in FIG. 2 are assigned to components having the same or equivalent functions respectively shown in FIG. 3.

FIG. 3 is a view showing configurations of the circuit chassis 1411 as a base and the engine base 1421 in the image light beam forming portion 14 shown in FIG. 2. FIG. 3A illustrates a general configuration of the circuit chassis 1411 and the engine base 1421 engaged with each other; FIG. 3B is a cross-sectional configuration in a region P shown in FIG. 3A, in which engagement portions of the circuit chassis 1411 and the engine base 1421 are engaged with each other; and FIG. 3C shows a cross-sectional configuration of a positioning portion Q for positioning the circuit chassis 1411 and the engine base 1421 at prespecified positions respectively.

In FIG. 3, the reference numeral 1411b denotes an engagement portion for the circuit chassis 1411 which engages with an engagement portion 1421b for the engine base 1421A; 1421c, a through-space defined by the engagement portion 1421a of the engine base 1421A and extending along the plane of the engine base 1421A (in the X-axial direction); 1411c, a projection for positioning on the circuit chassis 1411 in the positioning portion Q; 1411e, a hole for positioning of the engine base 1421A in the positioning portion Q; 1411f, a portion of a frame for the circuit chassis 1411 in which the projecting engagement portion 1411a is provided along the X-axial direction; and 1411g, a portion of the frame for the circuit chassis 1411 in which the projecting engagement portion 1411b is provided along the X-axial direction.

The circuit system unit 141 is coupled to the optical system unit 142 by moving the circuit chassis 1411 toward the engine base 1421 (1421A, 1421B) in the X-axial direction and in the -Z-axial direction. When the circuit chassis 1411 is moved in the X-axial direction, the projecting engagement portion 1411a of the frame portion 1411f for the circuit chassis 1411 is inserted into the space 1421c defined by the engagement portion 1421a for the engine base 1421A, and also the projecting engagement portion 1411b of the frame portion 1411g for the circuit chassis 1411 is inserted into a space defined by the engagement portion 1421b for the engine base 1421A. When the circuit chassis 1411 is moved in the X-axial direction, the projection 1411c for positioning the circuit chassis 1411 in the positioning portion Q slides in the X-axial direction in the state where the tip face contacts to a surface of the engine base 1421A.

When the engagement portions 1411a, 1411b are inserted into the space 1421c defined by the engagement portion 1421a and the space defined by the engagement portion 1421b down to a prespecified depth, respectively. Thus, movement of the circuit chassis 1411 in the X-axial direction is stopped at the position. At the position, the projection 1411c for positioning the circuit chassis 1411 can be inserted into the positioning hole 1421e for the engine base 1421A in the positioning portion Q. In the state, when the circuit chassis 1411 is pressed in the -Z-axial direction, the projection 1411c for positioning is inserted into the positioning hole 1411e. When the projection 1411c for positioning is inserted into the positioning hole 1411e, the circuit chassis 1411 is positioned at a prespecified position relative to the engine base 1421A, that is, relative to the engine base 1421.

To separate the circuit system unit 141 and the optical system unit 142 which are coupled to each other, the circuit chassis 1411 is moved toward the engine base 1421 (1421A, 1421B) in the Z-axial direction, the projection 1411c for positioning is pulled off from the positioning hole 1411e, and then the circuit chassis 1411 is moved in the X-axial direction to pull off the engagement portions 1411a, 1411b from the spaces defined by the engagement portions 1421a, 1421b respectively for disengagement.

The reference numerals used in FIG. 3 are used for the same components in FIG. 4.

FIG. 4 is a view illustrating a plane of a key portion of the engagement portion for engagement between the circuit chassis 1411 and the engine base 1421A.

In FIG. 4, the reference numeral 1421d denotes a through-space defined by the engagement portion 1421b for the engine base 1421A on a surface of the engine base 1421A and extending in the X-axial direction. The engagement portion 1411b for the circuit chassis 1411 is inserted into this space. Before the circuit system unit 141 and the optical system unit 142 are accommodated in the lower cabinet 13, the engagement portions 1411a and 1421b are engaged with each other and the engagement portions 1411b and 1421b are engaged with each other for enabling coupling between the circuit chassis 1411 and the engine base 1421A. Engagement between the circuit chassis 1411 and the engine base 1421A can be released even when the circuit system unit 141 and the optical system unit 142 are accommodated in the lower cabinet 13. When the two components are disengaged from each other, the circuit system unit 141 can be separated from the optical system unit 142 and taken out from the lower cabinet 13.

In this state, by adjusting a length of the connection line 143a to a prespecified value, the circuit unit 141 can be taken out to the outside while the optical system unit 142 is fixed in the lower cabinet 13 and the two components can electrically be connected to each other even in the state. Therefore repair or adjustment for the circuit system unit 141 can be performed while visually checking an image on the screen. It is needless to say that the connector 143b can be removed if necessary.

FIG. 5 is a view for illustrating operations for engagement between the circuit chassis 1411 and the engine base 1421A. FIG. 5 is a cross-sectional view taken along the line C-C′ in FIG. 4.

FIG. 5A shows the state before the circuit chassis 1411 slides toward the engine base 1421A in the X-axial direction, FIG. 5B shows the state after the circuit chassis 1411 slides toward the engine base 1421A in the X-axial direction, and FIG. 5C shows the state after the circuit chassis 1411 is correctly positioned to the engine base 1421A.

In FIG. 5A, the circuit chassis 1411 is in the state where the projecting engagement portion 1411a provided on the frame portion 1411f and the projecting engagement portion 1411b provided on the frame portion 1411g are on the straight line connecting the engagement portion 1421a to the engagement portion 1421b on the surface of the engine base 1421A. In the state, a tip face of the projection for 1411c for positioning the circuit chassis 1411 contacts a surface of the engine base 1421A, and the engagement portions 1411a, 1411b are at positions higher than the plane surface of the engine base 1421A respectively. Therefore, when the engagement portions 1411a, 1411b are moved in the X-axial direction, the engagement portions 1411a, 1411b can easily be inserted into the space 1421c defined by the engagement portion 1421a for the engine base 1421A and the space 1421d defined by the engagement portion 1421b. When the circuit chassis 1411 moves from the position shown in FIG. 5A toward the engine base 1421A by a distance x1 in the X-axial direction, the engagement portions 1411a, 1411b are inserted into the space 1421c defined by the engagement portion 1421a and the space 1421d defined by the engagement portion 1421b respectively to realize the state shown in FIG. 5B.

In FIG. 5B, tip portions of the engagement portions 1411a, 1411b for the circuit chassis 1411 are inserted into the spaces 1421c and 1421d respectively, and do not contact the engagement portions 1421a and 1421b for the engine base 1421A. In the state shown in FIG. 5B, the projection 1411c for positioning is substantially above the positioning hole 1421e. In the state, when the circuit chassis 1411 is moved in the direction Z₁ (in the -Z-axial direction) because of the self-weight or any other external force, the state is changed to the state shown in FIG. 5C.

In the state shown in FIG. 5C, the circuit chassis 1411 is shifted downward the engine base 1421, and portions of the engagement portions 1411a, 1411b contact the surface of the engine base 1421A, and the projection 1411C for positioning is inserted into the positioning hole 1421e. In the state, the circuit chassis 1411 and the engine base 1421 (1421A, 1421B) are coupled to each other, and the circuit system unit 141 and the optical system unit 142 are coupled to each other. In the state, a convex portion 1421m of the engine base 1421A is set in a concave portion 1411m of the circuit chassis 1411, preventing the circuit system unit 141 from being displaced from the position in the state in the X-axial direction.

When the circuit system unit 141 is separated from the optical system unit 142, at first the circuit chassis 1411 is changed from the position shown in FIG. 5C to the position shown in FIG. 5B, and then is moved by the distance x1 in the -X-axial direction to change to the state shown in FIG. 5A.

FIG. 6 and FIG. 7 are views other examples of coupling structures between the circuit chassis 1411 and the engine base 1421A. FIG. 6 is a view illustrating a coupling state between the circuit chassis 1411 and the engine base 1421A. FIG. 7 is an explanatory view for illustrating the coupling operation. FIG. 2 to FIG. 5 illustrate an example of a configuration in which the projecting engagement portions 1411a, 1411b for the circuit chassis 1411 are provided and inserted into the spaces 1421c, 1421d defined by the engagement portions 1421a, 1421b for the engine base 1421A respectively. FIG. 6 and FIG. 7 show an example of a configuration in which a hole is provided on the circuit chassis 1411 as an engagement portion and a convex portion provided on the engine base 1421A as an engagement portion is inserted into the hole.

In FIG. 6, the reference numeral 1411i denotes a rectangular hole provided as an engagement portion on a surface of the circuit chassis 1411; 1411j and 1411k, oblong holes respectively; 1411h, an end face of the circuit chassis 1411 in the X-axial direction; 1421h and 1421i, convex portions in an L-shape form provided on the engine base 1421A; and 1421j and 1421k, column convex portions. The rectangular hole 1411i is larger than an external dimension (on a plane perpendicular to the Z-axial direction) of the surface of the convex portions 1421i in an L-shape form, and the oblong holes 1411j, 1411k are larger than external dimensions (on a plane perpendicular to the Z-axial direction) of the column-like convex portions 1421j, 1421k.

When the circuit system unit 141 and the optical system unit 142 are coupled to each other, the column-shaped convex portions 1421j, 1421k are inserted to the oblong holes 1411j, 1411k, while the convex portion 1421i in an L-shaped form is inserted into the rectangular hole 1411i. When the circuit chassis 1411 is moved in he X-axial direction in the state described above, the oblong holes 1411j, 1411k, the rectangular hole 1411i, and the end face 1411h move toward the column-shaped convex portions 1421j, 1421k and the convex portions 1421i, 1421h each in an L-shaped form, respectively. Then, end faces of the holes and the end face 1411h get close to or contact side faces (in the -X-directional direction) of the column-shaped convex portions 1421j, 1421k and end faces of the convex portions 1421i, 1421h each in an L-shaped form (in the -X-directional direction), respectively. Especially, the end face of the rectangular hole 1411i and the end face 1411h go beneath portions 1421i₁, 1421h₁ of the convex portions 1421i, 1421h each in an L-shaped form which are parallel to the surface of the circuit chassis 1411. In the state, the circuit chassis 1411 is further moved in the -Z-axial direction, thus the circuit chassis 1411 and the engine base 1421A are coupled to each other. The circuit system unit 141 and the optical system unit 142 are coupled to each other as described above.

When the circuit system unit 141 is separated from the optical system unit 142, the coupling state between the circuit chassis 1411 and the engine base 1421A is released. In other words, the circuit chassis 1411 is moved in the Z-axial direction and then in the -X-axial direction to decouple the column-shaped convex portions 121j, 1421k and the convex portions 14211, 1421h from the oblong holes 1411j, 1411k, rectangular hole 1411i, and the end face 1411h, respectively. Thus, the circuit chassis 1411 is separated from the engine base 1421A. The circuit system 141 is separated from the optical system unit 142. Engagement between the circuit chassis 1411 and the engine base 1421A can be released even when the circuit system unit 141 and the optical system unit 142 are accommodated in the lower cabinet 13. When disengagement between the two components is carried out while the components are accommodated in the lower cabinet 13, the circuit system unit 141 can be separated from the optical system unit 142 and taken out from the lower cabinet 13.

FIG. 7 is a cross-sectional view of the configuration shown in FIG. 6 taken along the line D-D′ in the figure (a cross section on the ZX plane passing through the line DD′).

FIG. 7A illustrates the circuit chassis 1411 before being slid toward the engine base 1421A in the X-axial direction; FIG. 7B illustrates the circuit chassis 1411 after being slid toward the engine base 1421A in the X-axial direction; and FIG. 7C illustrates the circuit chassis 1411 after being moved from the position shown in FIG. 7B toward the engine base 1421A in the -Z-axial direction.

In FIG. 7A, the column-shaped convex portions 1421j, 1421k are provided as engagement portions for the engine base 1421A in the regions of the oblong holes 1411j, 1411k as engagement portions for the circuit chassis 1411, while the convex portion 1421i is in an L-shaped form as an engagement portion for the engine base 1421A in the region of the rectangular hole 1411i as an engagement portion for the circuit chassis 1411. In the state, a surface of the circuit chassis 1411 is at a position away from the surface of the engine 1421A. When the circuit chassis 1411 is moved by the distance x₁ from the position shown in FIG. 7A toward the engine base 1421A in the X-axial direction, the state is changed to the state shown in FIG. 7B.

In FIG. 7B, the end faces of the oblong holes 1411j, 1411k, the end face of the rectangular hole 1411i, and the end face 1411h are close to or contact side faces of the column-shaped convex portions 1421j, 1421k (in the -X-axial direction), the side faces of the convex portions 1421j, 1421h each in an L-shaped form (in the -X-axial direction), respectively. Especially the end face of the rectangular hole 1411i and the end face 1411h are beneath the portions 1421i₁, 1421h₁ of the convex portions 1421j, 1421h each in an L-shaped form, respectively, which are parallel to the surface of the circuit chassis 1411. When the circuit chassis 1411 is further moved in the -Z-axial direction in the state, the state is changed to the state shown in FIG. 7C.

In FIG. 7C, the circuit chassis 1411 is shifted downward to the engine base 1421A and contacts the surface of the engine base 1421A. In the state, the circuit chassis 1411 and the engine base 1421 (1421A, 1421B) are coupled to each other, thus the circuit system unit 141 and the optical system unit 142 being coupled to each other.

When the circuit system unit 141 is separated from the optical system unit 142, at first the circuit chassis 1411 is moved from the position shown in FIG. 7C toward the engine base 1421A in the Z-axial direction to change to the state shown in FIG. 7B, and then is moved by the distance X₁ from the position shown in FIG. 7B in the -X-axial direction to change to the state shown in FIG. 7A.

FIG. 8 is a view illustrating an appearance of the optical engine 1422 in the optical system unit 142 in the projection type image display apparatus 1 shown in FIG. 1.

The optical engine 1422 includes a lamp unit 1422d, an illumination light path portion 1422c, an optical image forming portion 1422b, and a projection lens 1422a. The lamp unit 1422d includes a lamp (not shown) as a light source, a reflector (not shown) for reflecting a light beam from the lamp in a prespecified direction, and the like. The illumination light path portion 1422c includes optical members such as a focusing lens (not shown), a polarizing beam splitter (not shown), and a color separating portion (not shown), and subject a light beam emitted from the lamp unit 1422d to various processing such as focusing, converting a polarizing beam, and color separation. The optical image forming portion 1422b includes light valves such as liquid crystal display devices for red, green, and blue light beams (not shown), color synthesizing units (not shown), and the like. Furthermore the optical image forming portion 1422b modules light beams (each of the red, green, and blue light beams) projected from the illumination light path portion 1422c to the light valve according to image signals with the light valve to obtain optical image light beams for the color light beams, synthesizes the optical image light beams with the synthesizing units to obtain an optical image white light beam, and outputs the white light beam to the projection lens 1422a. The projection lens 1422a enlarges the white light image beam and projects the enlarged light beam to a mirror (not shown).

The lamp unit 422d is dismountably attached to the illumination light path portion 1422c with respective coupling members. In other words, when the coupling members are coupled to each other, the lamp unit 1422d is coupled to the illumination light path portion 1422c. When the coupling members are decoupled from each other, the lamp unit 1422d is separated from the illumination light path portion 1422c. Furthermore, the lamp unit 1422d has a configuration in which a plurality of types of lamps can be attached.

FIG. 9 is a view for illustrating a configuration for coupling between the illumination light path portion 1422c and the lamp unit 1422d in the optical engine shown in FIG. 8. FIG. 9A is a view illustrating the state in which the lamp 1422d is removed from the illumination light path portion 1422c, while FIG. 9B is a view illustrating the lamp unit 1422d.

In FIG. 9, reference numerals 1501, 1502 denote pins provided as coupling members on the illumination light path portion 1422c; 1503, a coupling board provided as a member for coupling on the illumination light path portion 1422c; 1504 to 1506, holes provided on a surface of the coupling board 1503; 1600, a lamp as a light source; 1604 to 1606, pins provided as coupling members on the lamp unit 1422d; 1603, a coupling board provided as a coupling member on the lamp unit 1422d; and 1601 and 1602, holes provided on a surface of the coupling board 1603. The positions and dimensions of the pins 1501, 1502 correspond to those of the holes 1601, 1602, respectively, while the positions and dimensions of the pins 1604 to 1606 correspond to those of the holes 1504 to 1506, respectively.

When the lamp unit 1422d is coupled to the illumination light path portion 1422c, the pins 1604 and 1606 are inserted into the corresponding holes 1504 and 1506 respectively, and the pin 1501 is inserted into the corresponding hole 1601, and therefore the lamp unit 1422d is positioned at a predetermined position relative to the illumination light path portion 1422c.

The pin 1605 provided on the lamp unit 1422d is inserted into the hole 1505 provided on the coupling board. In this case, a plurality of types of lamps can be accommodated by preparing a plurality of combinations of the pin 1605 and the hole 1505. With this configuration, troubles caused by using different types of lamps can be eliminated. Furthermore, forms and combinations of optical members in the illumination light path portion 1422c can be changed according to the form of a lamp reflector.

Combinations of different types of lamps can be managed by changing a positional relationship between the pin 1502 provided on the illumination light path portion 1422c and the hole 1602 provided on the lamp unit 1422d, which also eliminates an erroneous combination of the pin and the hole. Especially, because the pin 1502 is directly provided on the illumination light path portion 1422c, the pin 1502 is directly linked to the illumination light path portion 1422c, so that a combination error between a lamp and the illumination light path portion 1422c never occurs.

Because of the features, reliability in a combination of lamps is secured, which prevents a work error in repair and maintenance works.

With the embodiments of the present invention described above with reference to FIGS. 1 to 9, in the projection type image display apparatus 1, engagement between the circuit system unit 141 and the optical system unit 142 can easily be performed or released by performing or releasing engagement between the engagement portions of the circuit system unit 141 and the engine base 1421A. Because of the features, the workability in an assembling work or an adjusting work is improved, which achieves cost reduction and facilitates the maintenance and repair works. Especially, in relation to the lower cabinet 13, after the circuit system unit 141 and the optical system unit 142, which were subjected to performance adjustment separately, are coupled to each other with the engagement portions described above, they can be embedded in an inner space 13a of the lower cabinet 13. Furthermore the circuit system unit 141 and the optical system unit 142 coupled to each other and accommodated within the inner space 13a can be separated from each other by releasing the engagement between the engagement portions described above. For example, only the circuit system unit 141 can be separated and taken out from the opening portion 13b while the optical system unit 142 is accommodated in the lower cabinet 13.

In the example of the projection type image display apparatus according to the present invention described above, the apparatus has a configuration in which a light beam from a light source is modulated with a light valve according to an image signal to form an optical image. The projection type image display apparatus according to the present invention, however, is not limited to the configuration described above. A projection type image display apparatus, in which the optical system unit is a CRT, can be applied to the present invention. The housing employed in the embodiment is a saparable housing including an upper housing (upper cabinet 12) for supporting a portion including the screen 11 and a lower housing for accommodating therein the circuit system unit 141 and the optical system unit 142 (lower cabinet 13). The present invention, however, is not limited to the above configuration, and the housing may be a monolithic housing in which the portion supporting the portion including the screen 11 and the portion for accommodating therein the circuit system unit 141 and the optical system unit 142 are integrally formed within one housing structure.

While a preferred embodiment of the present invention has been described using specific terms, such description is for illustrative purpose only, and it is to be understood that changes and variations may be made without departing from the spirit or scope of the following claims.

What is claimed is:

1. A projection type image display apparatus for projecting an optical image formed in response to an image signal onto a screen in an enlarged state, the apparatus comprising:
an optical system unit having a portion for forming the optical image and a projection lens for enlarging and projecting the optical image both supported on a first base;
a circuit system unit having a power circuit and a controlling circuit for controlling the portion for forming the optical image both supported on a second base; and
a housing having a portion for accommodating the optical system unit and the circuit system unit formed under the screen;
wherein the first and second bases have engagement portions capable of being disengageably engaged with each other, and the optical system unit and the circuit system unit are accommodated in the housing in the state where the optical system unit and the circuit system unit are coupled to each other with the engagement portions.

2. The projection type image display apparatus according to claim 1,
wherein the optical system unit forms an optical image by modulating a light beam from a light source with a light valve according to an image signal; and the light source, light valve, optical members for optically processing a light beam and guiding the light beam from the light source to the light valve, and the projection lens are supported on the first base; and
the circuit system unit has a power circuit for supplying power to the light source and the light valve and a controlling circuit for controlling the light valve both supported on a second base.

3. The projection type image display apparatus according to claim 1,
wherein, when the second base is relatively moved toward the screen along a surface of the first base, a surface of the engagement portion of the second base is engaged with the projecting portion of the engagement portion of the first base, and when the second base is relatively moved in a direction perpendicular to the surface of the first base, the second base is positioned at an engagement position.

4. The projection type image display apparatus according to claim 2,
wherein, when the second base is relatively moved toward the screen along a surface of the first base, a surface of the engagement portion of the second base is engaged with the projecting portion of the engagement portion of the first base, and when the second base is relatively moved in a direction perpendicular to the surface of the first base, the second base is positioned at an engagement position.

5. The projection type image display apparatus according to claim 1,
wherein the engagement portions are provided at a plurality of positions on the first and second bases.

6. The projection type image display apparatus according to claim 2,
wherein the engagement portions are provided at a plurality of positions on the first and second bases.

7. The projection type image display apparatus according to claim 3,
wherein the engagement portions are provided at a plurality of positions on the first and second bases.

8. The projection type image display apparatus according to claim 1,
wherein the circuit system unit has a configuration in which the power circuit and the controlling circuit are provided by wiring on a substrate, and the substrate is fixed in a region different from that in the engagement portions on the second base.

9. The projection type image display apparatus according to claim 2,
wherein the circuit system unit has a configuration in which the power circuit and the controlling circuit are provided by wiring on a substrate, and the substrate is fixed in a region different from that in the engagement portions on the second base.

10. The projection type image display apparatus according to claim 1,
wherein the optical system unit and the circuit system unit are electrically connected to each other with a connecting portion having a connection line and a connector.

11. The projection type image display apparatus according to claim 2,
wherein the optical system unit and the circuit system unit are electrically connected to each other with a connecting portion having a connection line and a connector.

12. The projection type image display apparatus according to claim 1,
wherein the housing has an opening on a rear surface opposite to a screen surface, and the opening is large enough to insert or remove a combination of the optical system unit and the circuit system unit coupled to each other with the engagement portions of the first and second bases.

13. The projection type image display apparatus according to claim 2,
wherein the housing has an opening on a rear surface opposite to a screen surface, and the opening is large enough to insert or remove a combination of the optical system unit and the circuit system unit coupled to each other with the engagement portions of the first and second bases.

14. The projection type image display apparatus according to claim 2,
wherein the light source and the optical members are coupled to each other with coupling members, and the coupling member for the light source has a configuration that enables a plurality of types of light sources to be attached by means of replacement.
